(19) United States
(12) Patent Application Publication
(10) Pub. No.: US 2025/0216821 A1
(43) Pub. Date: Jul. 3, 2025

(54) SYSTEMS AND METHODS FOR COAGULATION OPTIMIZATION

(71) Applicant: Aquatic Informatics ULC, Vancouver (CA)

(72) Inventors: Touraj Farahmand, Vancouver (CA); Brian Gouge, Vancouver (CA); Seyed Moein Elahi, Vancouver (CA); Matthew Gray, Vancouver (CA)

(73) Assignee: Aquatic Informatics ULC, Vancouver (CA)

(21) Appl. No.: 18/401,365

(22) Filed: Dec. 30, 2023

(51) Int. Cl. G05B 13/04; G05B 13/02

(52) U.S. Cl. CPC G05B 13/048; G05B 13/0265

(57) ABSTRACT

Systems and methods for coagulation optimization may include a control system deployed at the water treatment plant operating with a computing system executing various control model(s). The computing system may receive data including one or more water quality metrics and a settled turbidity setpoint of output water. The computing system may also receive a manual input corresponding to a dose of coagulant received during a manual override (e.g., at a first time instance). The control model(s) may determine the recommended dose of coagulant, while accounting for the manual input and the one or more metrics. When the control system has a handover from manual mode to automatic mode, the computing system may determine a recommended dose of coagulant based on the input data and the manual input. The computing system may transmit data corresponding to the recommended dose of coagulant to the control system of the water treatment plant.

### BACKGROUND

Water treatment is a process to remove certain particulates from water, for ensuring the safety and quality of water for various uses, including drinking, industrial processes, and irrigation. One of the primary challenges in water treatment is the effective removal of suspended particulates, which can include a range of materials such as sediment, algae, bacteria, and organic compounds. Coagulation is a widely used method for treating water to reduce turbidity and remove particulates. This process involves adding substances, known as coagulants, to water to facilitate the agglomeration of suspended particles into larger masses, which can then be more easily separated from the water.

### SUMMARY

In one aspect, this disclosure is directed to a method. The method may include receiving, by a control system at a water treatment plant, from a control model, a recommended dose of coagulant for source water into the water treatment plant. The recommended dose of coagulant may be determined by the control model based on one or more water quality metrics measured for the source water. The method may include receiving, by the control system during a manual override, a manual input for the dose of coagulant. The method may include providing, by the control system to the control model as feedback, data corresponding to the manual input during the manual override.

In some embodiments, the control model is hosted in a cloud environment, and the control system is locally deployed at the water treatment plant. In some embodiments, the control model includes i) a model predictive control system including a first dynamic model and an optimizer, and ii) a second dynamic model. In some embodiments, the model predictive control system is trained to generate the recommended dose of coagulant based on the one or more water quality metrics and a predicted settled turbidity from the second dynamic model. In some embodiments, the second dynamic model is trained to determine the predicted settled turbidity based on the one or more water quality metrics, the recommended dose of coagulant from the model predictive control system, and the data corresponding to the manual input. The data corresponding to the manual input may be provided as an input disturbance to the recommended dose of coagulant.

In some embodiments, the data corresponding to the manual input is provided to the control system as feedback, to maintain synchronization of the control model with the control system during the manual override. In some embodiments, the method includes switching, by the control system, the control model to an offline mode responsive to receiving the manual input according to the manual override. In some embodiments, the manual input is received at a first time instance. The method may include switching, by the control system at a second time instance subsequent to the first time instance, the control model to an online mode responsive to receiving an input to switch to automated control. The method may include receiving, by the control system, from the control model at a third time instance subsequent to the second time instance, a second recommended dose of coagulant determined by the control model, the control model determining the second recommended dose of coagulant according to the data corresponding to the manual input. In some embodiments, the one or more water quality metrics include a turbidity of the source water.

In another aspect, this disclosure is directed to a method. The method may include receiving, by a computing system configured to execute a control model, from a control system of a water treatment plant, input data comprising one or more metrics indicative of a water quality of source water and a settled turbidity setpoint of output water. The method may include receiving, by the computing system, from the control system of the water treatment plan as feedback, a manual input corresponding to a dose of coagulant received during a manual override at a first time instance. The method may include determining, by the control model of the computing system, a recommended dose of coagulant based on the input data and the manual input for a second time instance. The method may include transmitting, by the computing system, data corresponding to the recommended dose of coagulant to the control system of the water treatment plant.

In some embodiments, the control model includes i) a model predictive control system including a first dynamic model and an optimizer, and ii) a second dynamic model. In some embodiments, the model predictive control system is trained to generate the recommended dose of coagulant based on the one or more water quality metrics and a predicted settled turbidity from the second dynamic model. In some embodiments, the second dynamic model is trained to determine the predicted settled turbidity based on the one or more water quality metrics, the recommended dose of coagulant from the model predictive control system, and the manual input. The manual input may be provided as an input disturbance to the recommended dose of coagulant.

In some embodiments, the method includes determining, by the computing system, during the manual override at the first time instance, a recommended dose of coagulant. The method may include foregoing, by the computing system, transmitting data corresponding to the recommended dose of coagulant to the control system during the manual override. In some embodiments, the method includes detecting, by the computing system, a switch from an offline mode to an online mode, responsive to termination of the manual override. Transmitting the data corresponding to the recommended dose of coagulant to the control system of the water treatment plant may be performed responsive to detecting the switch.

In yet another aspect, this disclosure is directed to a system. The system may include a communication system communicably coupled to a control system of a water treatment plant. The computing system may include one or more processors configured to receive, via the communication system from the control system, input data comprising one or more metrics indicative of a water quality of source water and a settled turbidity setpoint of output water. The one or more processors may be configured to receive, via the communication system, from the control system as feedback, a manual input corresponding to a dose of coagulant received during a manual override at a first time instance. The one or more processors may be configured to determine a recommended dose of coagulant based on the input data and the manual input for a second time instance. The one or more processors may be configured to transmit, via the communication system to the control system, data corresponding to the recommended dose of coagulant.

In some embodiments, the system may further include the control system of the water treatment plant. In some embodiments, the one or more processors are configured to execute a control model to determine the recommended dose of coagulant. The control model may include i) a model predictive control system including a first dynamic model and an optimizer; and ii) a second dynamic model. In some embodiments, the model predictive control system is trained to generate the recommended dose of coagulant based on the one or more water quality metrics and a predicted settled turbidity from the second dynamic model. In some embodiments, the second dynamic model is trained to determine the predicted settled turbidity based on the one or more water quality metrics, the recommended dose of coagulant from the model predictive control system, and the manual input. The manual input may be provided as an input disturbance to the recommended dose of coagulant.

These and other features, together with the organization and manner of operation thereof, will become apparent from the following detailed description and the accompanying drawings.

### BRIEF DESCRIPTION OF THE DRAWINGS

FIG. 1 is a diagram of a system for treating water, according to one or more example implementations of the present disclosure.

FIG. 2 is a diagram of a control system for water treatment, according to one or more example implementations of the present disclosure.

FIG. 3 depicts a flowchart showing an example method of coagulation optimization, according to one or more example implementations of the present disclosure.

FIG. 4 depicts a user interface which may be displayed on an input/output device of the system of FIG. 1, according to one or more example implementations of the present disclosure.

FIG. 5A and FIG. 5B show a comparison of testing data of the control system of FIG. 2 to other solutions.

FIG. 6A and FIG. 6B show respective time series of coagulant dosage with respect to turbidity.

### DETAILED DESCRIPTION

Coagulation is used as part of water treatment, to remove suspended particulates from input (or source) water. Coagulation is one process in water treatment (typically pre-filtration) that involves the addition of chemicals, known as coagulants, to water to improve the removal of suspended particles. These particles, which can include dirt, microorganisms, and other contaminants, are often negatively charged and, as a result, repel each other and remain dispersed in the water. Coagulants may function by neutralizing these charges, allowing the particles to come closer together. Common coagulants may include poly-aluminum sulfate (PAS), ferric chloride, and polymeric compounds. Once the repulsive charges are neutralized, the particles can aggregate, or coalesce, into larger clumps, a process known as flocculation. The larger particle clumps, called flocs, may be easier to remove from the water by sedimentation (settling) or filtration. By effectively aggregating these small, suspended particles into larger ones, coagulation enhances the efficiency of the subsequent water filtration and purification processes. This makes it an essential step in ensuring the safety and clarity of drinking water, as well as in treating wastewater and industrial effluents.

Some solutions may implement an automated control with optimized coagulant dosing. For example, some solutions may use a feedforward approach in which an optimized dose of coagulant is computed from measured water quality characteristics or traits. Such optimized dose may be computed without regard to the actual process operation, and as such any changes or disturbances may not be accounted for by the computation. Additionally, complex regression models used for computing the optimized dose may be susceptible to overfitting that may cause instability in the calculated dose, and may thus be incapable of capturing the complex dynamic behavior of the coagulation process. For example, assuming that source water is introduced to a treatment system, in real-time, various sensors may measure water quality as the water comes in, and an optimizer of the treatment system may determine the optimized dose of coagulant based on the water quality. The optimizer may be or include a PID or PI controller configured to adjust the dose of the coagulant, to provide or produce a set water quality value (such as a set turbidity) as an output (e.g., by minimizing the error between the set water quality value to the measured water quality value). Such optimizers may be effective in providing a basic level of control, such as maintaining process variables within certain bounds to prevent unsafe or unstable conditions.

Some solutions may use the optimizer as a safeguard, while permitting manual control as a primary control of the coagulant. Typically, such systems may include a feedforward solution. For example, the feedforward mechanism may have an input which includes a water quality (e.g., of input water) and an output of an estimated dose of coagulant. The output of the feedforward solution may be provided to the water control system for controlling the coagulant dosage to water treatment process. Such feedforward solutions often times may involve complex regression models trained to determine the estimated dose of coagulant. However, such regression models are often susceptible to overfitting, which can result in over or under-dosed coagulant. Additionally, because coagulation can be a time-delayed process (e.g., approximately two hours from the source water being tested to that same source water being output resulting from water treatment) with significant amounts of noise in measurements, regression models may not be suitable for modeling such systems.

In some instances, an occasion or condition may result in a manual override of such automated control. For example, when an operator is aware of an impending storm, the operator may manually override the automated control of the feedforward system, to increase the coagulant dosage (e.g., to accommodate for the known relationship of storm or input water influx to increases in turbidity). As another example, an operator may manually override the automated control of coagulant dosage as a result of lab information and samples. In such examples, because the automated system is a feed-forward system, the automated system may not be made aware of the actual dosage (e.g., instead relying on the historical training data and input water quality). As such, when a handover occurs from manual override to the automated control, the automated control may be based on assumptions which do not account for the manual override. Such issues can result in model instability or runoff.

In various embodiments of the present solution, a control system deployed at the water treatment plant may operate with a computing system executing various control model(s). The computing system may receive input data including one or more metrics indicative of a water quality of source water and a settled turbidity setpoint of output water. The computing system may also receive, e.g., as feedback, an actual dosage corresponding to a dose of coagulant supplied (e.g., at a first time instance). The actual dosage may include, for example, a manual input, any feedback from a local controller or control loop, etc. The control model(s) may determine the recommended dose of coagulant continuously (or near-continuously/periodically, etc.), while accounting for the actual dosage and the one or more metrics. In some embodiments, the computing system may supply the recommended dose of coagulant to the control system of the water treatment plant, which may in turn display the recommended dose to an operator of the water treatment plant (e.g., even in instances of manual control). When the control system has a handover from manual mode to automatic mode (e.g., at a second time instance), the computing system may determine a recommended dose of coagulant based on the input data and the actual dosage. The computing system may also generate data corresponding to the recommended dose of coagulant and transmit the data to the control system of the water treatment plant. The data corresponding to the recommended dose may include, but is not limited to, data utilized in the generation of a graphical user interface that includes the recommended dose of coagulant, instructions for administering the recommended dose, trend information, etc.

In various embodiments of the present solution, the computing system may be hosted, deployed, or otherwise execute remotely (e.g., in the cloud). The control model(s) may include a model predictive control system and a dynamic model. The dynamic model may capture dynamical responses of the water treatment process (e.g., based on data from the water treatment plant) and feedback (e.g., including manual overrides performed at the water treatment plant), to compensate for model error. The model predictive control system may use predictions form the dynamic model and actual process feedback to determine recommended optimized dose. The control model(s) and control system deployed at the water treatment plant may be synchronized (e.g., by the control system providing continuous/periodic feedback to the computing system), even in instances where a manual override of the control system occurs.

Such systems and methods may provide for more accurate modeling and prediction of recommended dosage of coagulant, as compared to some solutions which may use regression models, particularly in instances where a switch or handover from manual to automatic control occurs. For example, because some solutions do not have feedback on manual override data of coagulant dosage, when such solutions switch from manual mode back to automatic control, the models which determine the recommended coagulant dosage do not have any awareness of coagulant dosage over the dead time (e.g., a duration of time from when source water enters the system [and water quality is tested], to coagulant being introduced as part of water treatment, and the treated water being discharged from the water treatment plant). In the present solution, because the manual inputs are provided as feedback (or input disturbances) to the control model(s), the control model(s) may use such manual inputs for determining a more accurate recommended dosage when the handover occurs.

Additional benefits of the present solution, as well as improvements over other solutions, are described in greater detail below.

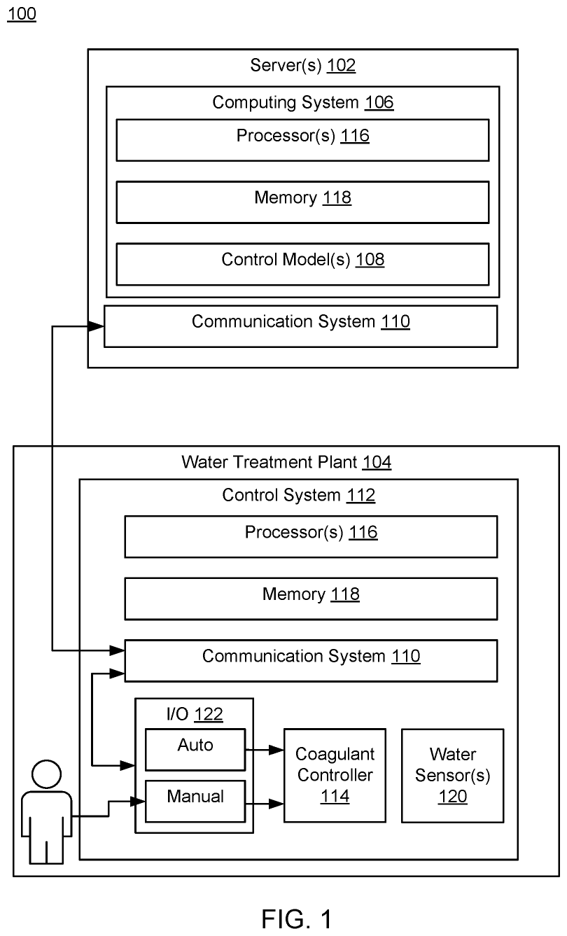

Referring now to FIG. 1, depicted is a block diagram of a system 100 for treating water, according to an example implementation of the present disclosure. The system 100 may include one or more server(s) 102 and a water treatment plant 104. The server(s) 102 may be remotely located from the water treatment plant 104 used to treat source water (e.g., water from various sources, such as lake water, river water, stream water, wastewater, and so forth). As described in greater detail below, the server(s) 102 may provide a computing system 106 configured to execute one or more control models 108 for generating a recommended dosage of coagulant for the water treatment plant 104. The server(s) 102 and water treatment plant 104 may include respective communication systems 110. According to various embodiments of the present solution, the computing system 106 may be configured to receive data/information/measurements/etc. from the water treatment plant 104. For example, the computing system 106 may be configured to receive target water quality metrics (or water quality setpoints), measured or sensed water quality metrics, and so forth. The computing system 106 may be configured to determine the recommended dosage based on or according to the target water quality metrics and the sensed water quality metrics. The computing system 106 may be configured to generate, transmit, send, communicate, or otherwise provide (e.g., via the respective communication systems 110) the recommended dosage of coagulant and corresponding data to a control system 112 of the water treatment plant 104. In some instances, the control system 112 may provide the recommended dosage of coagulant to a coagulant controller 114, to supply the recommended dosage of coagulant to input or supply water. In various instances, a user or operator at the water treatment plant 104 may manually override the recommended dosage (e.g., for various reasons or purposes described above).

In instances in which a manual override occurs (e.g., a handover from control of the dosage of coagulant by the computing system 106 to control of the dosage of coagulant by the user or operator), the computing system 106 may maintain synchronization with the control system 112. For example, control system 112 may be configured to transmit, communicate, or otherwise provide the actual (e.g., supplied) dosage of coagulant to the computing system 106 while the computing system 106 is not actively controlling dosage (or “offline”, from the perspective of the control system 112). By providing the actual dosage of coagulant to the computing system 106, the control model(s) 108 can accommodate for adjustments made to the recommended dosage during the manual override. When a subsequent handover occurs (e.g., a handover from control of the dosage of coagulant by the user or operator to control of the dosage of coagulant by the computing system 106), the control model(s) 108 may be configured to determine the recommended dosage of coagulant according to the actual dosage provided during the manual override, thereby avoiding inaccurate recommendations. Additional details of the system and corresponding processes are described in greater detail below.

The computing system 106 and control system 112 may include respective processor(s) 116 and memory 118. The processor(s) 116 can include a single processor, which can have one or more cores, or multiple processors. In some embodiments, processor(s) 116 can include a general-purpose primary processor as well as one or more special-purpose co-processors such as graphics processors (e.g., graphics processing units (GPUs)), digital signal processors (DSPs), or the like. The memory 118 can include one or more devices (e.g., random access memory (RAM), read-only memory (ROM), flash memory, hard disk storage, etc.) for storing data and/or computer code for completing and/or facilitating the various processes described herein. The memory 118 may include non-transient volatile memory, non-volatile memory, and non-transitory computer storage media. The memory 118 may include database components, object code components, script components, or any other type of information structure for supporting the various activities and information structures described herein. The memory 118 may be communicatively coupled to one or more processors and may include computer code or instructions for executing one or more processes described herein.

The server(s) 102 and water treatment plant 104 can include respective communication systems 110. The communication systems 110 can be configured to provide connections to various networks or to any other systems or devices via any number of wired or wireless communication protocols. In various embodiments, communication systems 110 can include a wired interface and/or a wireless interface implementing various data communication standards such as Wi-Fi, BLUETOOTH, cellular data network standards, and/or near-field communication (NFC). The devices and systems in FIG. 1 may interface via a network that may be composed of multiple connected sub-networks or autonomous system (AS) networks, which may meet at one or more of: an intervening network (a transit network), a dual-homed gateway node, a point of presence (POP), an Internet exchange Point (IXP), and/or additional other network boundaries. The network can be a local-area network (LAN) such as a company intranet, a metropolitan area network (MAN), a wide area network (WAN), an inter network such as the Internet, or a peer-to-peer network (e.g., an ad hoc Wi-Fi peer-to-peer network). The data links between nodes in the network may be any combination of physical links (e.g., fiber optic, mesh, coaxial, twisted-pair such as Cat-5 or Cat-6, etc.) and/or wireless links (e.g., radio, satellite, microwave, etc.).

The network can include carrier networks for mobile communication devices, e.g., networks implementing wireless communication protocols such as the Global System for Mobile Communications (GSM), Code Division Multiple Access (CDMA), Time Division Synchronous Code Division Multiple Access (TD-SCDMA), Long-Term Evolution (LTE), or any other such protocol including so-called generation 3G, 4G, 5G, and 6G protocols. In various arrangements, a network interface controller implements one or more network protocols such as Ethernet. The network may be public, private, or a combination of public and private networks. The network interfaces may include, or may be, one or more network interface controllers that can manage data exchanges with devices in the network (sometimes referred to as a network interface port). The network interface controller can handle the physical and data link layers of the Open Systems Interconnection (OSI) model for network communication. In some arrangements, some of the network interface controller's tasks may be handled by one or more processing circuits. In various arrangements, the network interface controller is incorporated into the one or more processing circuits (e.g., as circuitry on the same chip).

The water treatment plant 104 may include one or more water sensors 120. The water sensor(s) 120 may be or include any sensor designed or configured to measure, quantity, detect, determine, or otherwise generate data corresponding to one or more metrics indicative of a characteristic or trait of water under testing. The water sensor(s) 120 may include, for example, a turbidity sensor designed or configured to measure or sense a turbidity of water under testing. In some embodiments, the water sensor(s) 120 may include other sensors, such as pH meters, water flow sensors or flowmeters, dissolved oxygen probes, conductivity meters, nitrate sensors, chlorine analyzers, temperature sensors, and biological oxygen demand (BOD) sensors (to name a few non-limiting possibilities). The water sensor(s) 120 may be positioned or arranged to sense metric(s) indicative of water quality, characteristic, traits, or other quantifiable metrics of input (or source) water, output (or treated) water, and any intervening water between input and output. For example, the water treatment plant 104 may include sensor(s) positioned at various stages of the water treatment process, to generate data corresponding to various metric(s) indicative of the quality/characteristic/trait/metric(s) of water being treated.

The water treatment plant 104 may include a coagulant controller 114. The coagulant controller 114 may be or include any device, component, element, or hardware designed or configured to control a dosage of coagulant supplied to water. The coagulant controller 114 may include, for example, a processor communicably coupled to a valve configured to control a flow/amount/etc. of coagulant introduced to source water (e.g., in a flocculation tank, for example). The coagulant controller 114 may be communicably coupled to an input/output (I/O) device 122 (e.g., an input device, such as a keyboard, touch screen, etc., and display, for example). The coagulant controller 114 may be configured to receive inputs from the I/O device 122. A user or operator at the water treatment plant 104 may provide inputs to the I/O device 122, to provide for automated control of coagulant dosage and/or to provide for manual control of coagulant dosage. The coagulant controller 114 may be configured to control an actual amount of coagulant supplied to the source water based on the input(s) received from the user or operator.

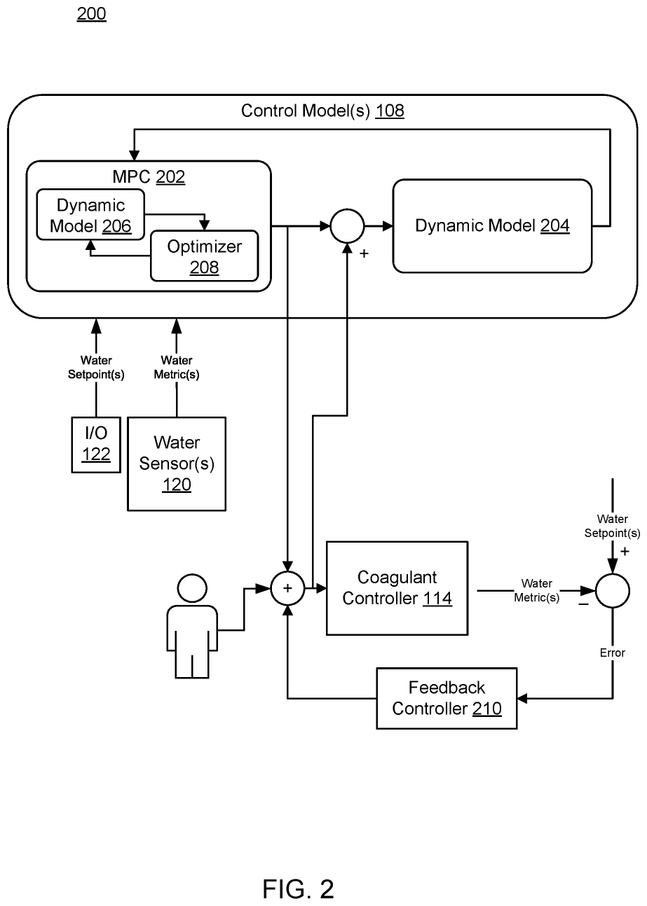

Referring now to FIG. 2, and with continued reference to FIG. 1, depicted is a control diagram 200 for water treatment, according to an example implementation of the present disclosure. As shown in FIG. 2, the control models 108 may include a model predictive control (MPC) system 202 (also referred to as “MPC 202”) and a dynamic model 204. The MPC 202 may include a dynamic model 206 and an optimizer 208. In some embodiments, the dynamic model 204 and dynamic model 206 (e.g., of the MPC 202) may be the same. In this regard, the dynamic models 204, 206 may be separate instances of the same dynamic model. For example, the dynamic models 204, 206 may have at least some of the same configuration data (e.g., weights, biases, and/or other configuration data) as one another. In some embodiments, the dynamic models 204, 206 may be identical (e.g., having the same configuration data). As described in greater detail below, the MPC 202 may be tuned or otherwise configured to determine a recommended dosage of coagulant for input water, based on water setpoint(s) and water metric(s). The dynamic model 204 may be trained or otherwise configured to determine a predicted or estimated settled turbidity, based on water metric(s), the recommended dosage, and the actual dosage of coagulant supplied as part of water treatment. In this regard, the dynamic model 204, 206 may be trained to determine a predicted or estimated settled turbidity, and deployed (e.g., multiple instances being deployed) both in the MPC 202 and separately.

The control model(s) 108 may include an MPC 202. The MPC 202 may be or include a process control algorithm or solution used to control a process (such as providing a recommended dosage of coagulant) while satisfying a set of constraints. The MPC 202 may be tuned or configured to predict future process behavior (e.g., estimated coagulant dosage) based on water metrics and past operation of the water treatment plant 104 (e.g., past dosage in relation to corresponding water metrics). For example, the MPC 202 may be tuned or configured, e.g., during a tuning/testing/training phase, based on samples of water quality/metrics/characteristics at various time instances (e.g., for the same water treatment plant 104 and/or for a wide variety of water treatment plants 104) and under various operational/environmental conditions (such as dry times, rain or storms, snowfall, etc.), and corresponding dosages of coagulant used during the water treatment process at such time instances. The constraints may include, for example, water setpoints which are predetermined, set by a user or operator at the water treatment plant 104, etc. The constraints may include, for instance, an upper or lower bound of actual values, a rate of change for the output (e.g., output from the dynamic model 204), an upper and lower bound on actual values and a rate of change for control dose, etc. The water setpoints may include a maximum settled turbidity (e.g., 1.0 NTU, for example), though other setpoints corresponding to other water metrics may be used or otherwise optimized for by the MPC 202.

As shown in FIG. 2, the MPC system 202 may include a dynamic model 206 and an optimizer 208. As noted above, the dynamic model 206 may be substantially the same as dynamic model 204. The dynamic model 206 (and also, dynamic model 204) may be configured to receive data indicative of or corresponding to various water metrics and setpoints. The dynamic model 206 may be configured to receive the water metrics and setpoints from the control system 112 of the water treatment plant 104 (e.g., via the communication systems 110). In some embodiments, the computing system 106 may be configured to execute a routine to call the control system 112, to request the water metrics and setpoints (e.g., at various intervals). In some embodiments, the control system 112 may be configured to push the water metrics and setpoints periodically. The dynamic model 206 (and similarly, the dynamic model 204) may be configured to forecast, predict, estimate, or otherwise determine a settled turbidity of the output (or treated) water based on the water metrics. The optimizer 208 may be configured to compute, identify, calculate, derive, or otherwise determine a recommended dosage of coagulant to supply to the input (or source) water, to provide or achieve the water setpoint(s). The dynamic model 206 of the MPC 202 and optimizer 208 may cycle back and forth until a recommended dosage of coagulant is derived which is likely to produce the corresponding water setpoint (e.g., the settled turbidity).

The dynamic models 204, 206 may be trained or otherwise configured to determine a modeled/estimated/predicted settled turbidity. The dynamic models 204, 206 may be configured to determine the predicted settled turbidity based on or according to the recommended dosage (e.g., from the MPC 202), the water metric(s), and actual dosage of coagulant supplied as part of water treatment at the water treatment plant 104. The dynamic model 204 may be configured to receive the actual dosage of coagulant via the communication systems 110 from the control system 112 of the water treatment plant 104 (e.g., in a manner similar to receiving the water metric(s) and water setpoint(s) as described above). The actual dosage of coagulant may be provided as an input disturbance to the dynamic model 204. For example, the actual dosage may be provided as an input disturbance to the recommended dosage of coagulant from the MPC 202.

In various instances, the recommended dosage and actual dosage may be the same. For example, a user or operator may accept the recommended dosage from the MPC 202 (e.g., at the I/O DEVICE 122), may select for automatic or automated control via the MPC 202, and so forth. In some instances, the recommended dosage and the actual dosage may be different. For example, a user or operator may select (e.g., on or via the I/O DEVICE 122) to manually operate or control the water treatment process, and thus may manually override the recommended dosage of coagulant. The user or operator may select to manually operate the water treatment process in advance of a storm or other environmental condition which is likely to result in a decrease in water quality (e.g., to proactively mitigate potential water quality issues of the source water). Similarly, the recommended dosage and the actual dosage may be different, due to feedback from the feedback controller 210.

When the user or operator selects to manually operate or control the water treatment process, the control system 112 may be configured to switch, control, or otherwise trigger control of the dosage of coagulant via the control model(s) 108 to be offline. For example, the control system 112 may be configured to display recommended dosages from the control model(s) 108, but may not use the recommended dosages as inputs to be supplied to the coagulant controller 114. Rather, the control system 112 may supply manual inputs from the user or operator to the coagulant controller 114. In this regard, the control model(s) 108 may be “offline” (e.g., in that they are not actively controlling the coagulant dosage supplied to the water treatment process). In the offline mode, the control model(s) 108 may be configured to determine the recommended dosage of coagulant, but the recommended dosage may not be supplied by the control system 112 to the coagulant controller 114. In some embodiments, the MPC 202 may provide the recommended dosage of coagulant to the I/O device 122 of the control system 112, but the recommended dosage may simply be displayed (e.g., and not used by the coagulant controller 114) responsive to the manual operation.

The control system 112 may be configured to supply/transmit/communicate the actual dosage of coagulant to the computing system 106 (e.g., to provide to the dynamic model 204). The control system 112 may communicate the actual dosage of coagulant to the computing system 106 continuously/periodically/synchronously/etc. The control system 112 may communicate the actual dosage of coagulant to the computing system 106, to maintain synchronization of the control model(s) 108 with the control system 112 during the manual override. For example, by providing the actual dosage of coagulant to the dynamic model 204, the estimated settled turbidity determined by the dynamic model 204 can account for information/data/inputs received while the control model(s) 108 are “offline” from the perspective of the control system 112. For instance, because the water treatment process has a significant dead time (e.g., the duration between source water being input to the water treatment plant 104 and treatment of the same source water being completed), during a manual override, any manual inputs provided during the dead time would have a delayed impact on water metrics. As such, the manual inputs during the manual override being supplied to the dynamic model 204 may permit the dynamic model 204 to account for the dynamic changes of the water treatment process during the manual override.

The dynamic model 204 may be configured to determine the estimated settled turbidity of the treated water, based on the recommended dosage of coagulant (e.g., from the MPC 202), the water metric(s), and the actual dosage of coagulant (e.g., provided as a disturbance to the recommended dosage of coagulant). In instances in which the recommended dosage and actual dosage are the same, the resulting disturbance supplied to the dynamic model may be zero (e.g., because there is no delta between the recommended dosage and actual dosage). In instances in which the recommended dosage and the actual dosage are different (e.g., based on the manual inputs provided by the user or operator at the water treatment plant 104 as part of the manual override), the resulting disturbance may represent, indicate, or otherwise identify the difference between the recommended dosage and actual dosage. The dynamic model 204 may be configured to determine the estimated settled turbidity based on the disturbance and water metrics. The dynamic model 204 may be configured to supply, transmit, communicate, or otherwise provide the estimated settled turbidity of the treated water as feedback to the MPC 202. In this regard, the MPC 202 may be configured to account for the disturbance (e.g., as reflected by an updated/revised estimated settled turbidity determined by the dynamic model 204), in determining the recommended dosage of coagulant, which may in turn be supplied to the control system 112 (e.g., for display via the I/O device 122).

Referring still to FIG. 2, in addition to providing the actual dosage of coagulant to the dynamic model 204 as a disturbance, the actual dosage of coagulant (e.g., whether the recommended dosage provided by the MPC 202 or manual input during a manual override) may be supplied to the coagulant controller 114. The coagulant controller 114 may introduce, supply, or otherwise provide the actual dosage of coagulant to supply water (e.g., in a flocculation tank). The water sensor(s) 120 may be configured to measure, detect, sense, or otherwise quantify water metrics as the actual dosage of coagulant is supplied to the source water (e.g., in the flocculation tank). For example, the water sensor(s) 120 may be configured to generate data corresponding to a settled turbidity of source water as the coagulant is supplied to the source water. The water sensor(s) 120 may be configured to quantify the water metrics (and report such metrices to the control system 112 and/or computing system 106) continuously or near-continuously. In some embodiments, the water sensor(s) 120 may be configured to generate data corresponding to the settled turbidity after a predetermined duration from the coagulant being supplied to the source water. In this regard, the water sensor(s) 120 may be configured to generate an supply data corresponding to the water metrics continuously and/or periodically.

As shown in FIG. 2, the control system 112 may further include a feedback controller 210. The feedback controller 210 may be or include any device, component, element, or hardware designed or configured to provide local feedback to the water treatment process, to minimize error between the water metrics and corresponding water setpoints. In some embodiments, the feedback controller 210 may include a proportional-integral (PI) or proportional-integral-derivative (PID) controller designed or configured to provide local feedback to the water treatment process. For example, the feedback controller 210 may be configured to compute an error based on a difference between the water metrics and water quality setpoint(s). For example, the feedback controller 210 may be configured to calculate an error value as the difference between a desired setpoint (e.g., water quality setpoint) and a measured process variable (e.g., corresponding water metric). The feedback controller 210 may be configured to apply a correction based on proportional, integral, and, in the case of PID, derivative terms, to minimize the error value. The feedback controller 210 may be configured to provide the correction to the manual operator (e.g., via the I/O device 122), to an adder (e.g., which sums together the actual/recommended dosage with the correction), and so forth.

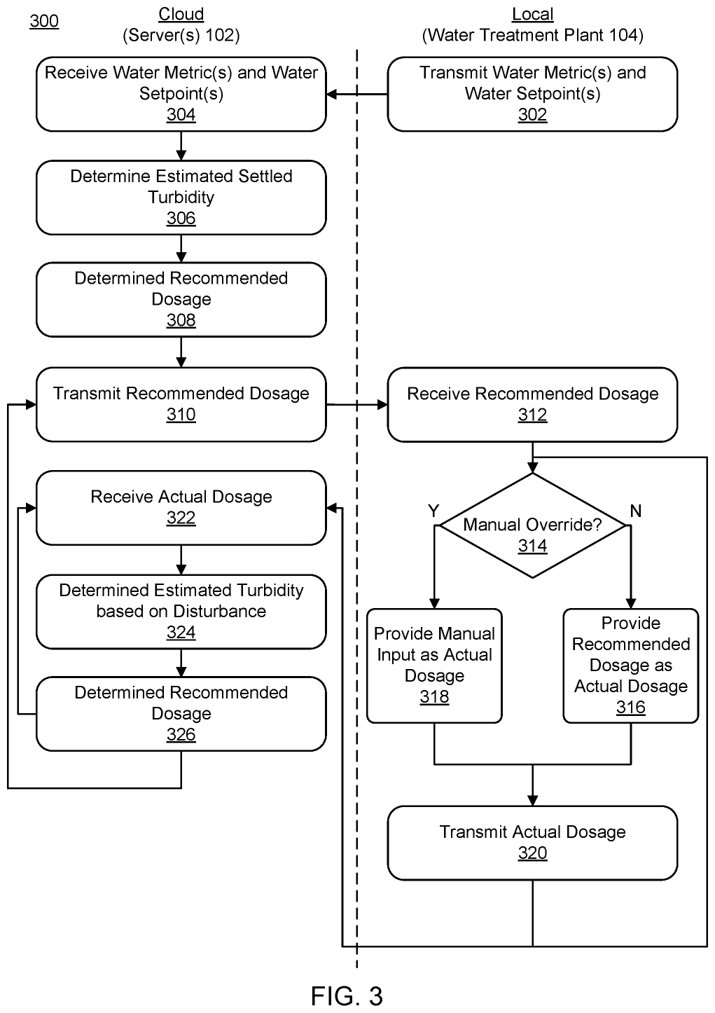

Referring now to FIG. 3, and with continued reference to FIG. 1 and FIG. 2, depicted is a flowchart showing an example method 300 of coagulant optimization, according to an example implementation of the present disclosure. The method 300 may be performed by the devices, components, elements, and/or hardware described above with reference to FIG. 1 and FIG. 2. For example, and in some embodiments, some steps of the method 300 may be performed locally (e.g., at the water treatment plant 104 by the control system 112) and steps may be performed remotely in the cloud (e.g., at the server(s) 102 by the computing system 106). While shown as certain steps being performed by a respective device/component/element at a corresponding location, it is noted that the present disclosure is not limited to the particular arrangements shown in FIG. 3. To the contrary, some steps could be performed locally and/or remotely in various embodiments.

At step 302, the control system 112 may transmit water metric(s) and water quality setpoint(s). Prior to transmitting the water metric(s) and water setpoint(s) at step 302, in some embodiments, the method may include identifying the water metric(s) and water setpoint(s). In some embodiments, the control system 112 may receive the water metric(s) from various water sensor(s) 120 of the water treatment plant 104. The control system 112 may receive the water metric(s) at various intervals (e.g., periodically, continuously, near-continuously, etc.). In some embodiments, the control system 112 may receive the water quality setpoint(s) from the I/O device 122 (e.g., from a user or operator of the water treatment plant 104). In some embodiments, the water setpoint(s) may be predetermined or preset for a particular water treatment plant 104.

The control system 112 may transmit the water metric(s) and water setpoint(s) to the computing system 106. In some embodiments, the control system 112 may transmit the water metric(s) and water setpoint(s), via the respective communication systems 110, to the computing system 106. The control system 112 may transmit the water metric(s) and water setpoint(s) at various intervals. For example, and in some embodiments, the control system 112 may transmit the water metric(s) synchronously and/or periodically (e.g., at a predetermined/defined frequency or interval). In this regard, the control system 112 may transmit the water metric(s) throughout execution of the method 300. The control system 112 may transmit the water quality setpoint(s) at various intervals. For example, the control system 112 may transmit the water setpoint(s) once, responsive to any change in the quality setpoint(s), etc.

At step 304, the computing system 106 may receive water metric(s) and water setpoint(s). In some embodiments, the computing system 106 may receive the water metric(s) and water quality setpoint(s) from the control system 112. The computing system 106 may receive the water metric(s) and water setpoint(s) via the respective communication systems 110 from the control system 112.

At step 306, the computing system 106 may determine an estimated settled turbidity. In some embodiments, the computing system 106 may execute, deploy, provide, or otherwise maintain one or more control model(s) 108 for determining the estimated settled turbidity. For example, the computing system 106 may maintain the MPC 202 and dynamic model 204, where the MPC 202 includes a respective dynamic model 206 and an optimizer 208. The dynamic model 206 and dynamic model 204 may be the same dynamic model. The computing system 106 may execute the dynamic models 204, 206 to determine the estimated settled turbidity. The computing system 106 may provide the water metric(s) (e.g., received from the control system 112 at step 304) to the dynamic models 204, 206. The dynamic models 204, 206 may determine the estimated settled turbidity based on or according to the water metric(s).

At step 308, the computing system 106 may determine a recommended dosage of coagulant. In some embodiments, the optimizer 208 of the MPC 202 may determine the recommended dosage. The computing system 106 may execute the optimizer 208 of the MPC 202 to determine the recommended dosage. The optimizer 208 may determine the recommended dosage based on or according to the estimated settled turbidity (e.g., determined by the dynamic model 206) and the water quality setpoint(s) (e.g., received from the control system 112 at step 304). The optimizer 208 may provide the recommended dosage to the dynamic model 206 as feedback for re-estimating the settled turbidity. In some embodiments, the computing system 106 may cycle between execution of the dynamic model 206 and optimizer 208, to determine the estimated settled turbidity and recommended dosage, until the estimated settled turbidity is substantially the same as the water quality setpoint corresponding to the estimated settled turbidity. In this regard, the computing system 106 may execute steps 306 and 308 until the estimated settled turbidity is substantially the same as the corresponding water quality setpoint.

At step 310, the computing system 106 may transmit the recommended dosage. In some embodiments, the computing system 106 may transmit the recommended dosage via the communication systems 110 to the control system 112. The computing system 106 may transmit the recommended dosage determined by the MPC 202, responsive to the estimated settled turbidity being substantially equal to the corresponding water quality setpoint. Alternatively, computing system 106 may generate data corresponding to the recommended dosage. At step 312, the control system 112 may receive the recommended dosage (or data corresponding to the recommended dosage). The control system 112 may receive, via the communication systems 110, the recommended dosage determined by the MPC 202 executed by the computing system 106. The control system 112 may receive the recommended dosage determined by the MPC 202 for display via the I/O device 122 to an operator or user at the water treatment plant. In this regard, the recommended dosage may be displayed (via the I/O device 122), regardless of whether the dosage supplied as part of water treatment is manually provided (as part of a manual override) or automatically provided (e.g., the recommended dosage received at step 310 is supplied as the actual dosage).

At step 314, the control system 112 may determine whether a manual override has occurred. The control system 112 may determine whether a manual override has occurred, based on whether any manual inputs have been received (e.g., via the I/O device 122) from an operator at the water treatment plant. As described above, an operator at the water treatment plant may perform a manual override in various instances, such as when an impending storm or other environmental condition is likely to decrease water quality of the source water. Where a manual override has not occurred, the method 300 may proceed to step 316. On the other hand, where a manual override has occurred, the method 300 may proceed to step 320.

At step 316, where a manual override has not occurred, the control system 112 may provide the recommended dosage as the actual dosage. In some embodiments, the control system 112 may provide the recommended dosage as the actual dosage to the coagulant controller 114. The control system 112 may provide the actual dosage to the coagulant controller 114, to cause the coagulant controller 114 to supply coagulant to the source water (e.g., in a flocculation tank) in an amount equal to the actual dosage. In this regard, where the recommended dosage is used as the actual dosage provided to the coagulant controller 114, the control model(s) 108 of the computing system 106 may be actively controlling the dosage of coagulant supplied to water as part of water treatment.

At step 318, where a manual override has occurred, the control system 112 may provide the manual input as the actual dosage. In some embodiments, the control system 112 may provide the manual input as the actual dosage to the coagulant controller 114. For example, the manual input may be an adjustment (e.g., by the user or operator provided via the I/O device 122) to the recommended dosage, a specific value manually input by the user or operator (e.g., via the I/O device 122) of the dosage, etc. The control system 112 may provide the actual dosage to the coagulant controller 114, to cause the coagulant controller 114 to supply coagulant to the source water (e.g., in a flocculation tank) in an amount equal to the actual dosage. In this regard, where the recommended dosage is not used as the actual dosage (rather, a manual input is used as the actual dosage), the control model(s) 108 of the computing system 106 may be actively controlling the dosage of coagulant supplied to water as part of water treatment.

At step 320, the control system 112 may transmit the actual dosage. In some embodiments, responsive to performing either of steps 316 or 320, the method 300 may proceed to step 320, where the control system 112 transmits the actual dosage to the computing system 106. The control system 112 may transmit the actual dosage to the computing system 106 responsive to the coagulant being supplied (e.g., by the coagulant controller 114) to the supply water. In this regard, the control system 112 may transmit the actual dosage, to synchronize the coagulant dosage supplied to the water at the water treatment plant 104 with the information used by the computing system 106 to determine the recommended dosage as described below.

At step 322, the computing system 106 may receive the actual dosage. In some embodiments, the computing system 106 may receive the actual dosage via the communication systems 110 from the control system 112. The computing system 106 may receive the actual dosage of coagulant supplied to the water at the water treatment plant, as an input disturbance to the dynamic model 204. For example, the computing system 106 may execute the dynamic model 204 to determine the estimated settled turbidity, based on the recommended dosage of coagulant (e.g., determined by the MPC 202). The computing system 106 may receive the actual dosage of coagulant as an input disturbance to the recommended dosage of coagulant, thereby determining the settled turbidity based on actual conditions at the water treatment plant (e.g., including the actual supplied dosage of coagulant).

At step 324, the computing system 106 may determine an estimated settled turbidity based on the input disturbance. In some embodiments, the computing system 106 may execute the dynamic model 204 to determine the estimated settled turbidity based on the input disturbance and the recommended dosage of coagulant. In some embodiments, the computing system 106 may execute the dynamic model 204 to determine the estimated settled turbidity based on the recommended dosage, input disturbance, and water metric(s), e.g., received at a nearest iteration of step 304 (or the most recent water metric(s)). In some embodiments, the computing system 106 may supply the estimated settled turbidity determined at step 324 as feedback to the MPC 202.

At step 326, the computing system 106 may determine the recommended dosage. In some embodiments, the computing system 106 may execute the MPC 202 to determine the recommended dosage. Similar to step 308, the computing system 106 may execute the MPC 202, to determine the recommended dosage based on the water metric(s), estimated settled turbidity (e.g., determined at step 324, which itself is based on the input disturbance corresponding to the manual input), and water quality setpoint(s).

Following step 326, the method 300 may proceed back to step 310, where the computing system 300 transmits the recommended dosage to the control system 112. In this regard, the control system 112 (e.g., the I/O device 122) may display the recommended dosage of coagulant determined by the computing system 300, which is based on the actual dosage 320 provided as a disturbance to the control model(s) at step 324. Such implementations may provide for real-time feedback on recommended dosage, while avoiding potential runoff or error in recommended dosage.

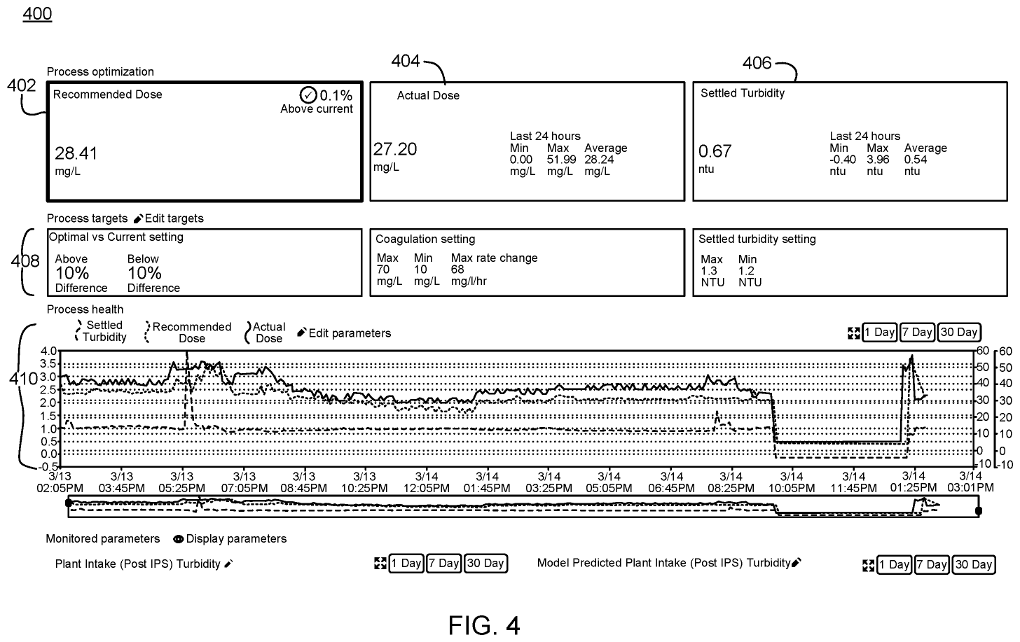

Referring now to FIG. 4, depicted is an example user interface 400 which may be displayed at the I/O device 122, in various embodiments of the present solution. As shown in FIG. 4, the user interface 400 may include various user interface elements or fields which provide information relating to the water treatment (specifically, coagulation) process. For example, the user interface 400 may include a user interface field 402 which indicates a recommended dosage, a user interface field 404 which indicates an actual dosage, a user interface field 406 which indicates a measured settled turbidity, various user interface fields 408 which indicate process targets, and a user interface field 410 which indicates a time progression. As shown in the user interface field 410, the time progression may indicate a time lapse or series (e.g., over a one day, seven day, 30 day, etc. period) of settled turbidity, recommended dosage, and actual dosage of coagulant supplied to water as part of the water treatment process. As shown in FIG. 4, the recommended dosage may largely track the actual dosage supplied to water as part of the water treatment process.

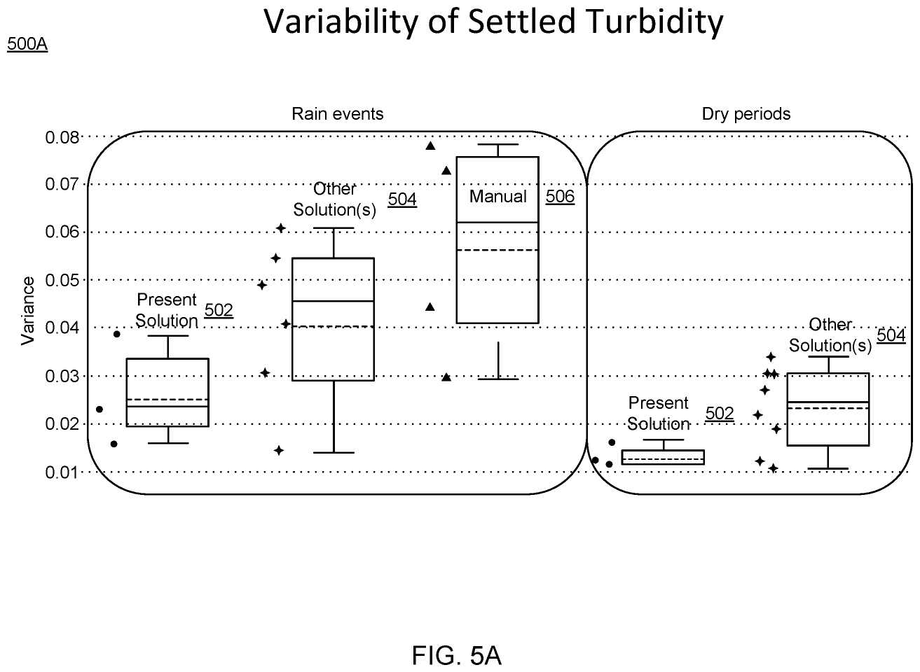

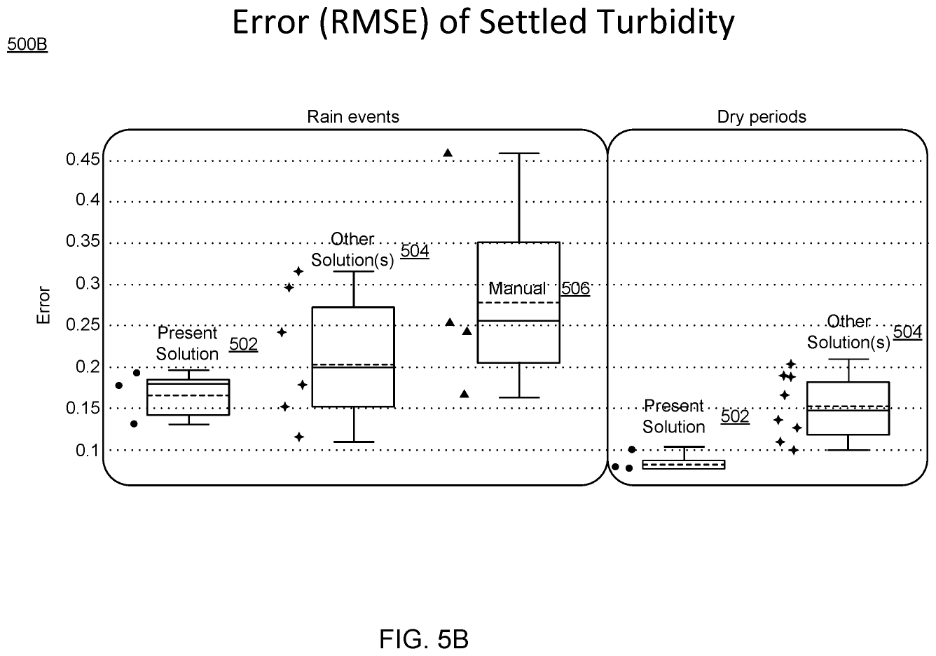

Referring now to FIG. 5A and FIG. 5B, depicted is a comparison of results achieved by the systems and methods described herein (e.g., present solution 502) and other solutions 504 (e.g., including manual operation of the coagulant controller 114). Specifically, FIG. 5A shows a variability of settled turbidity, for both rain events and dry events, provided by the systems and methods described herein as compared to other solutions 504. FIG. 5B shows an error of settled turbidity (e.g., a root mean square error (RMSE)) of settled turbidity, for both rain events and dry events, provided by the systems and methods described herein. As shown in FIG. 5A and FIG. 5B, the systems and methods described herein may have a lower distribution of variance (as reflected in FIG. 5A) and lower distribution of error (as reflected in FIG. 5B), when compared to other solutions 504 (such as those described above involving regression models without feedback on actual dosage), and manual control 506. Such lower distributions are achieved both in rain events, and even lower distribution in dry events. Particularly with respect to dry events, it is noted that the variance and error of the systems and methods described herein may perform substantially at or better than other solutions tested.

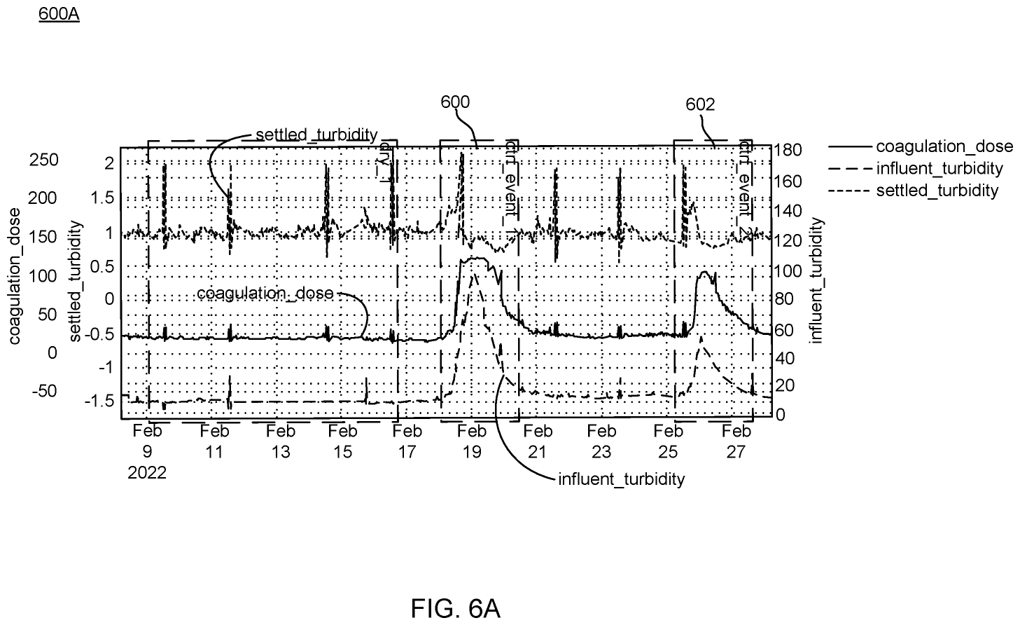

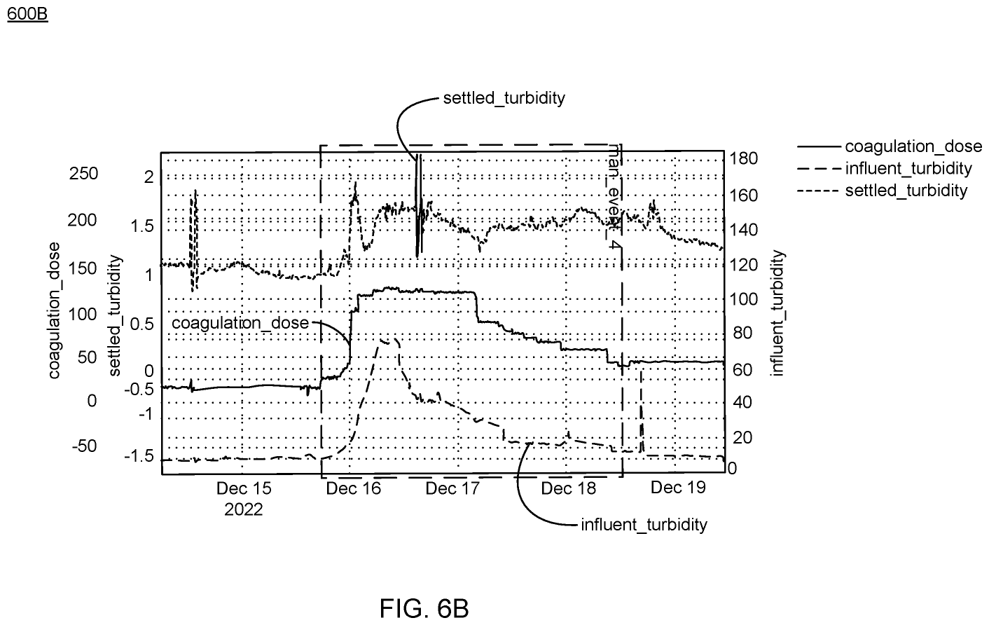

Referring now to FIG. 6A and FIG. 6B, depicted are time series showing example testing data which may be used for training the control model(s) 108 described herein. While two time series are shown, it is noted that any number of time series may be used, representing any number of control events and results. In fact, it is noted that, as additional time series and data is used for training the control model(s) 108, the control model(s) 108 may better predict the estimated settled turbidity and recommended dosages.

As shown in FIG. 6A and FIG. 6B, the time series may include a settled turbidity (e.g., of output or treated water), an influent turbidity (e.g., of input or source water), and coagulation dose suppled to the source water, during a non-storm (FIG. 6A) and a storm event (FIG. 6B). As shown in central region 600 of FIG. 6A, the coagulant dose substantially plateaus, but the influent turbidity has a peak within the plateau of the coagulant dose, which demonstrates an overdose scenario. The overdose scenario occurring in central region 600 may be in response to dosing, for example, during manual control or based on a recommended dosage provided by a model trained based on historical overdoses of coagulant. Similarly, FIG. 6B illustrates an overdose scenario where the influent turbidity peaks within the plateau of the coagulant dose on Dec. 16, 2022. Right-hand region 602 of FIG. 6A shows the coagulant dose largely following the shape of the influent turbidity, which demonstrates an implementation of an automated control solution for dosing coagulant using the systems and methods described herein.

It is noted that some data may be better for training than other data. For example, training a model using data that is based on historical overdoses of coagulant may result in the model generating a recommended dosage that overcorrects or overcompensates for a particular influent turbidity. Alternatively, training a model using historical data in which a coagulant dose increases as turbidity increases and decreases as turbidity decreases, likely results in the model generating a recommended dosage that does not overcorrect or overcompensate for particular influent turbidities. For example, as shown in the comparison of regions 600 and 602, the automated control solutions described herein more closely tracks the influent turbidity, thereby producing results which do not have overdosage of coagulant.

Various functionality of the disclosed approach can be realized, in various embodiments, using any combination of software and hardware, such as dedicated components and/or programmable processors and/or other programmable devices. The various processes described herein can be implemented on the same processor or different processors in any combination. Where components are described as being configured to perform certain operations, such configuration can be accomplished, e.g., by designing electronic circuits to perform the operation, by programming programmable electronic circuits (such as microprocessors) to perform the operation, or any combination thereof. Further, while the embodiments described above may make reference to specific hardware and software components, those skilled in the art will appreciate that different combinations of hardware and/or software components may also be used and that particular operations described as being implemented in hardware might also be implemented in software or vice versa. “Software” refers generally to sequences of instructions that, when executed by processing units cause systems/devices (or portions thereof) to perform various operations, thus defining one or more specific machine embodiments that execute and perform the operations of the software programs. The instructions can be stored as firmware residing in read-only memory and/or program code stored in non-volatile storage media that can be read into volatile working memory for execution by processing units. Software can be implemented as a single program or a collection of separate programs or program modules that interact as desired. From local storage (or non-local storage), processing units can retrieve program instructions to execute and data to process in order to execute various operations described above.

The embodiments described herein have been described with reference to drawings. The drawings illustrate certain details of specific embodiments that provide the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory).

Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be provided as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. It is understood that all such variations are within the scope of the disclosure. Likewise, software and web implementations of the present disclosure may be accomplished with standard programming techniques with rule based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

What is claimed is:

1. A method, comprising:
receiving, by a control system at a water treatment plant, from a control model, a recommended dose of coagulant for source water into the water treatment plant, the recommended dose of coagulant determined by the control model based on one or more water quality metrics measured for the source water;
receiving, by the control system during a manual override, a manual input for the dose of coagulant; and
providing, by the control system to the control model as feedback, data corresponding to the manual input during the manual override.

2. The method of claim 1, wherein the control model is hosted in a cloud environment, and wherein the control system is locally deployed at the water treatment plant.

3. The method of claim 1, wherein the control model comprises i) a model predictive control system comprising a first dynamic model and an optimizer, and ii) a second dynamic model.

4. The method of claim 3, wherein the model predictive control system is trained to generate the recommended dose of coagulant based on the one or more water quality metrics and a predicted settled turbidity from the second dynamic model.

5. The method of claim 4, wherein the second dynamic model is trained to determine the predicted settled turbidity based on the one or more water quality metrics, the recommended dose of coagulant from the model predictive control system, and the data corresponding to the manual input, and wherein the data corresponding to the manual input is provided as an input disturbance to the recommended dose of coagulant.

6. The method of claim 3, wherein the first dynamic model comprises a first instance of a dynamic model, and the second dynamic model comprises a second instance of the dynamic model.

7. The method of claim 1, wherein the data corresponding to the manual input is provided to the control system as feedback, to maintain synchronization of the control model with the control system during the manual override.

8. The method of claim 1, further comprising switching, by the control system, the control model to an offline mode responsive to receiving the manual input according to the manual override.

9. The method of claim 8, wherein the manual input is received at a first time instance, the method further comprising:
switching, by the control system at a second time instance subsequent to the first time instance, the control model to an online mode responsive to receiving an input to switch to automated control; and
receiving, by the control system, from the control model at a third time instance subsequent to the second time instance, a second recommended dose of coagulant determined by the control model, the control model determining the second recommended dose of coagulant according to the data corresponding to the manual input.

10. The method of claim 1, wherein the one or more water quality metrics comprise a turbidity of the source water.

11. A method comprising:
receiving, by a computing system configured to execute a control model, from a control system of a water treatment plant, input data comprising one or more metrics indicative of a water quality of source water and a settled turbidity setpoint of output water;
receiving, by the computing system, from the control system of the water treatment plan as feedback, a manual input corresponding to a dose of coagulant received during a manual override at a first time instance;
determining, by the control model of the computing system, a recommended dose of coagulant based on the input data and the manual input for a second time instance; and
transmitting, by the computing system, data corresponding to the recommended dose of coagulant to the control system of the water treatment plant.

12. The method of claim 11, wherein the control model comprises i) a model predictive control system comprising a first dynamic model and an optimizer, and ii) a second dynamic model.

13. The method of claim 12, wherein the model predictive control system is trained to generate the recommended dose of coagulant based on the one or more water quality metrics and a predicted settled turbidity from the second dynamic model.

14. The method of claim 13, wherein the second dynamic model is trained to determine the predicted settled turbidity based on the one or more water quality metrics, the recommended dose of coagulant from the model predictive control system, and the manual input, and wherein the manual input is provided as an input disturbance to the recommended dose of coagulant.

15. The method of claim 11, further comprising:
determining, by the computing system, during the manual override at the first time instance, a recommended dose of coagulant; and
foregoing, by the computing system, transmitting data corresponding to the recommended dose of coagulant to the control system during the manual override.

16. The method of claim 11, further comprising detecting, by the computing system, a switch from an offline mode to an online mode, responsive to termination of the manual override,
wherein transmitting the data corresponding to the recommended dose of coagulant to the control system of the water treatment plant is performed responsive to detecting the switch.

17. A computing system comprising:
a communication system communicably coupled to a control system of a water treatment plant; and
one or more processors configured to:
receive, via the communication system from the control system, input data comprising one or more metrics indicative of a water quality of source water and a settled turbidity setpoint of output water;
receive, via the communication system, from the control system as feedback, a manual input corresponding to a dose of coagulant received during a manual override at a first time instance;
determine a recommended dose of coagulant based on the input data and the manual input for a second time instance; and
transmit, via the communication system to the control system, data corresponding to the recommended dose of coagulant.

18. The system of claim 17, further comprising the control system of the water treatment plant.

19. The system of claim 17, wherein the one or more processors are configured to execute a control model to determine the recommended dose of coagulant, wherein the control model comprises:
i) a model predictive control system comprising a first dynamic model and an optimizer; and
ii) a second dynamic model.

20. The system of claim 19, wherein:
the model predictive control system is trained to generate the recommended dose of coagulant based on the one or more water quality metrics and a predicted settled turbidity from the second dynamic model;
the second dynamic model is trained to determine the predicted settled turbidity based on the one or more water quality metrics, the recommended dose of coagulant from the model predictive control system, and the manual input, and wherein the manual input is provided as an input disturbance to the recommended dose of coagulant.
